(19) United States
(12) Patent Application Publication
(10) Pub. No.: US 2024/0331893 A1
(43) Pub. Date: Oct. 3, 2024

(54) MAGNETIC MODULE, HOLLOW COIL AND COMPOSITE WIRE THEREOF

(71) Applicant: Delta Electronics, Inc., Taoyuan City (TW)

(72) Inventors: Chih-Ho LAI, Taoyuan City (TW); Cai-Li GU, Taoyuan City (TW); Chun-Ching YEN, Taoyuan City (TW); Shao-Dong ZHANG, Taoyuan City (TW); Huai-Pei TUNG, Taoyuan City (TW); Yue TSAO, Taoyuan City (TW)

(21) Appl. No.: 18/458,838

(22) Filed: Aug. 30, 2023

(30) Foreign Application Priority Data
Mar. 31, 2023 (CN) 202310337119.7

(51) Int. Cl. H01B 7/00; H01F 5/00

(52) U.S. Cl. CPC H01B 7/0009; H01F 5/00

(57) ABSTRACT

A composite wire is provided. The composite wire includes a single core wire, a plurality of twisted wires, and an insulation layer. In a cross section of the composite wire, the twisted wires surround the single core wire. The twisted wires are configured along the circumferential direction of the single core wire. Each twisted wire comprises a plurality of conductive wires. The insulation layer covers the twisted wires. Each conductive wire has a conductive wire diameter, and the single core wire diameter of the single core wire is greater than the conductive wire diameter.

### CROSS REFERENCE TO RELATED APPLICATIONS

This Application claims priority of China Patent Application No. 202310337119.7, filed on Mar. 31, 2023, the entirety of which is incorporated by reference herein.

### BACKGROUND OF THE INVENTION

### Field of the Invention

The present invention relates to a composite wire, and, in particular, to a composite wire adapted to form a hollow coil.

### Description of the Related Art

In conventional switching power supply transformers, LITZ wires are utilized to form coils. The LITZ wires surround the lead frame to form the coil. The coil is supported by the lead frame. Conventionally, the thickness of the lead frame needs to be at least 0.6 mm to avoid short-circuiting between the LITZ wire and the iron core. The LITZ wire can easily scatter during the winding process, which increases the difficulty of manufacturing. Additionally, a conventional coil must be supported by a lead frame, and the coil cannot be flattened.

### BRIEF SUMMARY OF THE INVENTION

An embodiment of the present invention provides a composite wire. The composite wire includes a single core wire, a plurality of twisted wires, and an insulation layer. In a cross section of the composite wire, the twisted wires surround the single core wire. The twisted wires are configured along the circumferential direction of the single core wire. Each twisted wire comprises a plurality of conductive wires. The insulation layer covers the twisted wires. Each conductive wire has a conductive wire diameter, and the single core wire diameter of the single core wire is greater than the conductive wire diameter.

In one embodiment, the single core wire diameter is greater than four times the conductive wire diameter.

In one embodiment, the single core wire diameter is greater than the twisted wire diameter of the twisted wire.

In one embodiment, the single core wire diameter is greater than two times the twisted wire diameter.

In one embodiment, the single core wire is a single core enameled wire.

In one embodiment, the composite wire further comprises a first adhesive layer, wherein the first adhesive layer is disposed on an inner side of the insulation layer, and the twisted wires are attached to the insulation layer by the first adhesive layer.

In one embodiment, the composite wire further comprises a second adhesive layer, wherein the second adhesive layer is disposed between the twisted wires and the single core wire.

In another embodiment, a hollow coil is provided. The hollow coil includes a composite wire. The composite wire extends along a spiral path. The composite wire includes a single core wire, a plurality of twisted wires, and an insulation layer. In a cross section of the composite wire, the twisted wires surround the single core wire. The twisted wires are configured along the circumferential direction of the single core wire. Each twisted wire comprises a plurality of conductive wires. The insulation layer covers the twisted wires. Each conductive wire has a conductive wire diameter, and the single core wire diameter of the single core wire is greater than the conductive wire diameter.

In another embodiment, a magnetic module is provided. The magnetic module includes an iron core unit and a composite wire. The composite wire surrounds the iron core unit. The composite wire includes a single core wire, a plurality of twisted wires, and an insulation layer. In a cross section of the composite wire, the twisted wires surround the single core wire. The twisted wires are configured along the circumferential direction of the single core wire. Each twisted wire comprises a plurality of conductive wires. The insulation layer covers the twisted wires. Each conductive wire has a conductive wire diameter, and the single core wire diameter of the single core wire is greater than the conductive wire diameter.

In the composite wire of the embodiment of the invention, the single core wire has thicker diameter, and provides structure support for the composite wire. The composite wire can be wound automatically. Compared with the conventional art, the coil of the embodiment of the invention has decreased manufacturing cost and improved reliability. Additionally, the coil of the embodiment of the invention can be flattened, and has improved stress resistance (for example, 1500 Vac). When the coil of the embodiment of the invention is combined with the lead frame, the thickness of the lead frame can be reduced because the lead frame does not need to provide the supporting function.

### BRIEF DESCRIPTION OF THE DRAWINGS

The present invention can be more fully understood by reading the subsequent detailed description and examples with references made to the accompanying drawings, wherein:

FIG. 1 shows a hollow coil of the embodiment of the invention;

FIG. 2 is a cross sectional view of the composite wire of a first embodiment of the invention;

FIG. 3 is a cross sectional view of the composite wire of a second embodiment of the invention;

FIG. 4A is a perspective view of a magnetic module of an embodiment of the invention;

FIG. 4B is an exploded view of the magnetic module of the embodiment of the invention; and

FIG. 5 shows a portion of a magnetic module of another embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

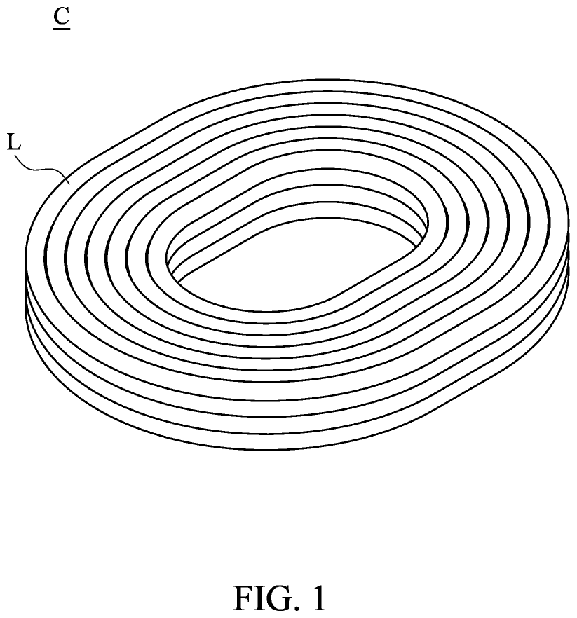

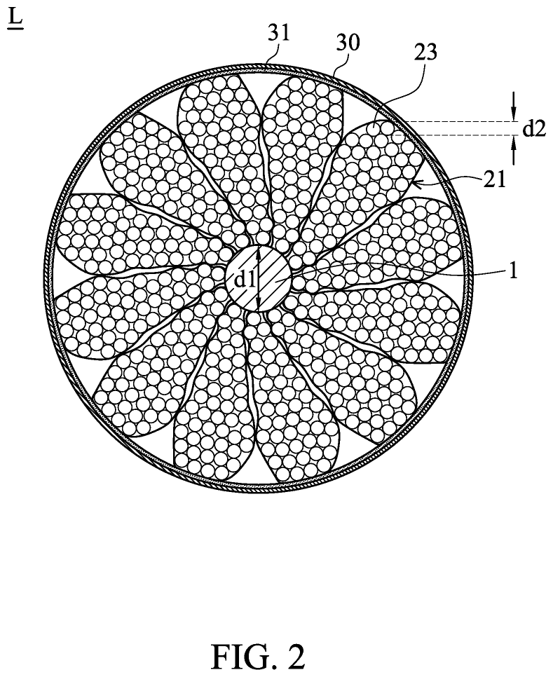

FIG. 1 shows a hollow coil of the embodiment of the invention. FIG. 2 is a cross sectional view of the composite wire of a first embodiment of the invention. With reference to FIGS. 1 and 2, the hollow coil C of the embodiment of the invention includes a composite wire L. The composite wire L extends along a spiral path. The composite wire L includes a single core wire 1, a plurality of twisted wires 21 and an insulation layer 30. In a cross section of the composite wire L, the twisted wires 21 surround the single core wire 1. The twisted wires 21 are configured along the circumferential direction of the single core wire 1. Each twisted wire 21 comprises a plurality of conductive wires 23. The insulation layer 30 covers the twisted wires 21. Each conductive wire 23 has a conductive wire diameter d2, and the single core wire diameter d1 of the single core wire 1 is greater than the conductive wire diameter d2. The single core wire 1 provides structural support for the hollow coil C.

With reference to FIG. 2, in one embodiment, the single core wire diameter d1 is greater than four times the conductive wire diameter d2. Therefore, the single core wire 1 provides sufficient structural support for the hollow coil C.

With reference to FIG. 2, in one embodiment, the single core wire 1 is a single core enameled wire.

With reference to FIG. 2, in one embodiment, the composite wire L further comprises a first adhesive layer 31. The first adhesive layer 31 is disposed on an inner side of the insulation layer 30. The twisted wires 21 are attached to the insulation layer 30 by the first adhesive layer 31. The insulation layer 30 and the first adhesive layer 31 restrict the twisted wires 21. In one embodiment, the insulation layer 30 can be made of plastic or other insulation materials.

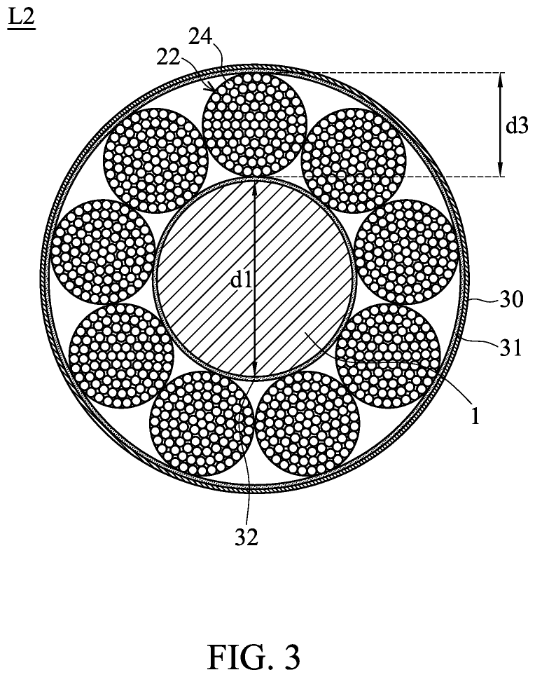

FIG. 3 is a cross sectional view of the composite wire of a second embodiment of the invention. With reference to FIG. 3, the composite wire L2 of the second embodiment includes a single core wire 1, a plurality of twisted wires 22 and an insulation layer 30. Each twisted wire 22 comprises a plurality of conductive wires 24. In this embodiment, the single core wire diameter d1 of the single core wire 1 is greater than the twisted wire diameter d3 of each twisted wire 22. The single core wire 1 thus provides additional structural support for the hollow coil C.

With reference to FIG. 3, in one embodiment, the single core wire diameter d1 is greater than two times the twisted wire diameter d3. The single core wire 1 thus provides sufficient structural support for the hollow coil C.

With reference to FIG. 3, in one embodiment, the composite wire L2 further comprises a second adhesive layer 32. The second adhesive layer 32 is disposed between the twisted wires 22 and the single core wire 1. The second adhesive layer 32 restrict the twisted wires 22.

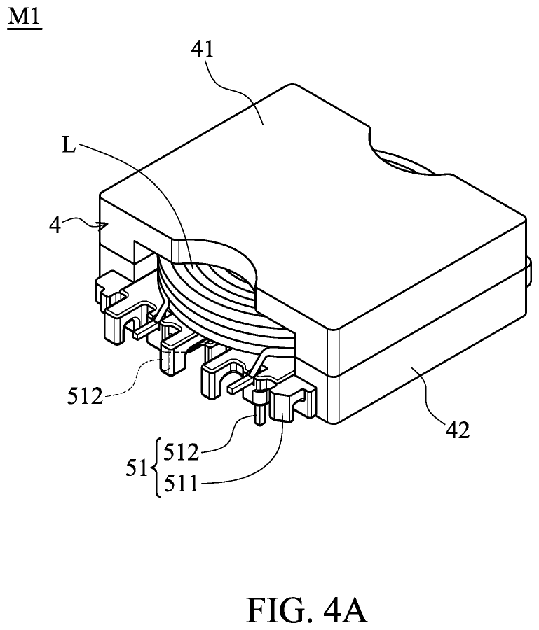

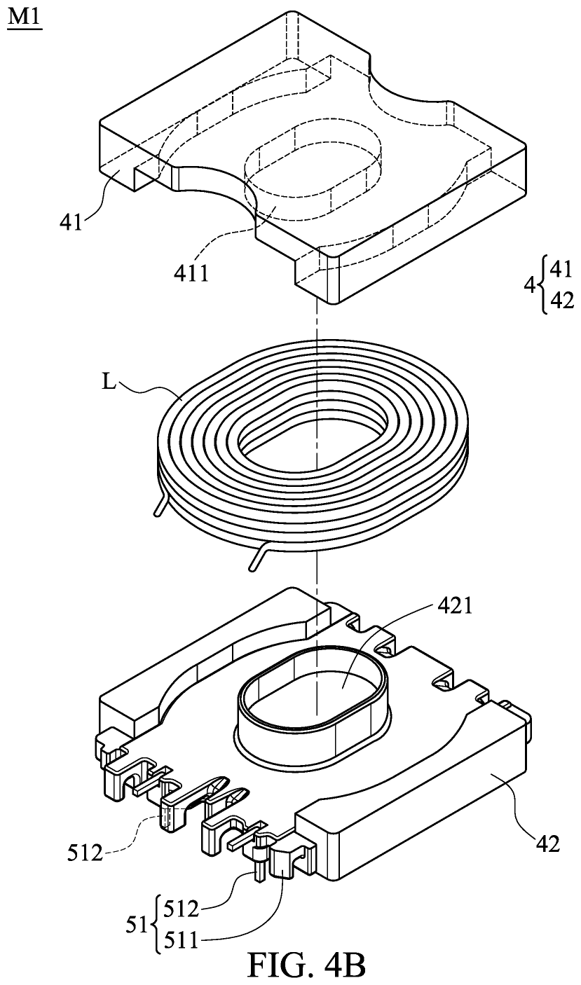

FIG. 4A is a perspective view of a magnetic module of an embodiment of the invention. FIG. 4B is an exploded view of the magnetic module of the embodiment of the invention. With reference to FIGS. 4A and 4B, in another embodiment, a magnetic module M1 is provided. The magnetic module M1 includes an iron core unit 4 and a composite wire L. The iron core unit 4 includes a first iron core 41 and a second iron core 42. The first iron core 41 has a first post 411. The second iron core 42 has a second post 421. The composite wire L surrounds the first post 411 and the second post 421 of the iron core unit 4. The composite wire L surrounds at least a portion of the iron core unit 4.

With reference to FIGS. 4A and 4B, in one embodiment, the magnetic module M1 further comprises a lead frame 51. The lead frame 51 is disposed between the first iron core 41 and the second iron core 42. The lead frame 51 includes a base 511 and a plurality of pins 512. The pins 512 are disposed on the base 511. The composite wire L is disposed on the lead frame 51 and connected to the pins 512.

With reference to FIGS. 4A and 4B, in one embodiment, at least a portion of the composite wire L is sandwiched between the first iron core 41 and the second iron core 42.

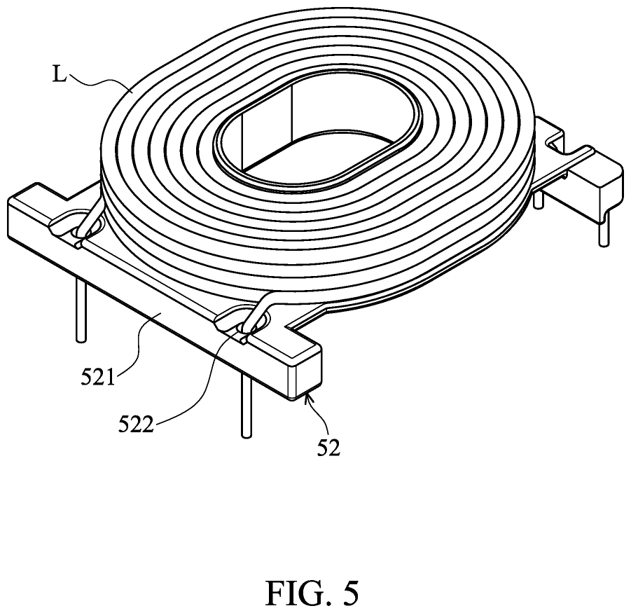

FIG. 5 shows a portion of a magnetic module of another embodiment of the invention. With reference to FIG. 5, the magnetic module has a lead frame 52. The lead frame 52 comprises a base 521. The base 521 has a plurality through holes 522. The composite wire L is disposed on the lead frame 52 and passes through the through holes 522. In this embodiment, the through holes 522 restrict the position of the composite wire L.

In the composite wire of the embodiment of the invention, the single core wire has thicker diameter, and provides structure support for the composite wire. The composite wire can be wound automatically. Compared with the conventional art, the coil of the embodiment of the invention has decreased manufacturing cost and improved reliability. Additionally, the coil of the embodiment of the invention can be flattened, and has improved stress resistance (for example, 1500 Vac). When the coil of the embodiment of the invention is combined with the lead frame, the thickness of the lead frame can be reduced because the lead frame does not need to provide the supporting function.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A composite wire, comprising:
a single core wire;
a plurality of twisted wires, wherein in a cross section of the composite wire, the twisted wires surround the single core wire, the twisted wires are configured along a circumferential direction of the single core wire, and each twisted wire comprises a plurality of conductive wires; and
an insulation layer, covering the twisted wires, wherein each conductive wire has a conductive wire diameter, and a single core wire diameter of the single core wire is greater than the conductive wire diameter.

2. The composite wire as claimed in claim 1, wherein the single core wire diameter is greater than four times the conductive wire diameter.

3. The composite wire as claimed in claim 1, wherein the single core wire diameter is greater than a twisted wire diameter of the twisted wire.

4. The composite wire as claimed in claim 3, wherein the single core wire diameter is greater than two times the twisted wire diameter.

5. The composite wire as claimed in claim 1, wherein the single core wire is a single core enameled wire.

6. The composite wire as claimed in claim 1, further comprising a first adhesive layer, wherein the first adhesive layer is disposed on an inner side of the insulation layer, and the twisted wires are attached to the insulation layer by the first adhesive layer.

7. The composite wire as claimed in claim 1, further comprising a second adhesive layer, wherein the second adhesive layer is disposed between the twisted wires and the single core wire.

8. A hollow coil, comprising:
a composite wire, wherein the composite wire extends along a spiral path, and the composite wire comprises:
a single core wire;
a plurality of twisted wires, wherein in a cross section of the composite wire, the twisted wires surround the single core wire, the twisted wires are configured along the circumferential direction of the single core wire, and each twisted wire comprises a plurality of conductive wires; and
an insulation layer, covering the twisted wires, wherein each conductive wire has a conductive wire diameter, and the single core wire diameter of the single core wire is greater than the conductive wire diameter.

9. The hollow coil as claimed in claim 8, wherein the single core wire diameter is greater than four times the conductive wire diameter.

10. The hollow coil as claimed in claim 8, wherein the single core wire diameter is greater than the twisted wire diameter of the twisted wire.

11. The hollow coil as claimed in claim 10, wherein the single core wire diameter is greater than two times the twisted wire diameter.

12. The hollow coil as claimed in claim 8, wherein the single core wire is a single core enameled wire, the composite wire further comprises a first adhesive layer, wherein the first adhesive layer is disposed on an inner side of the insulation layer, and the twisted wires are attached to the insulation layer by the first adhesive layer.

13. A magnetic module, comprising:
an iron core unit;
a composite wire, surrounding at least a portion of the iron core unit, wherein the composite wire comprises:
a single core wire;
a plurality of twisted wires, wherein in a cross section of the composite wire, the twisted wires surround the single core wire, the twisted wires are configured along the circumferential direction of the single core wire, and each twisted wire comprises a plurality of conductive wires; and
an insulation layer, covering the twisted wires, wherein each conductive wire has a conductive wire diameter, and the single core wire diameter of the single core wire is greater than the conductive wire diameter.
